(19) United States
(12) Patent Application Publication
(10) Pub. No.: US 2012/0103506 A1
(43) Pub. Date: May 3, 2012

(54) Magnetic Sheet Systems

(75) Inventor: Thomas G. Love, Marietta, OH (US)

(73) Assignee: MAGNUM MAGNETICS CORPORATION, Marietta, OH (US)

(21) Appl. No.: 13/287,055

(22) Filed: Nov. 1, 2011

Related U.S. Application Data
(60) Provisional application No. 61/409,189, filed on Nov. 2, 2010.
(60) Provisional application No. 61/446,791, filed on Feb. 25, 2011.
(60) Provisional application No. 61/483,211, filed on May 6, 2011.

(51) Int. Cl. B32B 37/14; B32B 37/02

(52) U.S. Cl. 156/244.11; 156/500

(57) ABSTRACT

Systems relating to providing flexible magnetizable sheets having writable and printable surfaces in a single continuous-flow production process.

### CROSS-REFERENCE TO RELATED APPLICATION

The present application is related to and claims priority from prior provisional application Ser. No. 61/409,189, filed Nov. 2, 2010, entitled “COATED MAGNETIC SHEET SYSTEMS”; and, this application is related to and claims priority from prior provisional application Ser. No. 61/446,791, filed Feb. 25, 2011, entitled “MAGNETIC SHEET SYSTEMS”; and, this application is related to and claims priority from prior provisional application Ser. No. 61/483,211, filed May 6, 2011, entitled “MAGNETIC SHEET SYSTEMS”, the contents of all of which are incorporated herein by this reference and are not admitted to be prior art with respect to the present invention by the mention in this cross-reference section.

### BACKGROUND

This invention relates to providing systems for improved flexible magnetic sheets including methods of manufacturing such sheets. More particularly, this invention relates to providing a system for producing printable/writable flexible magnetizable sheets in a single continuous-flow production process.

The potential applications for flexible magnetic materials are abundant, extending into many industrial fields and areas of commerce. Providing these materials in the form of flexible magnetic sheets, which are configured to include one or more writable/printable faces, further expands the usefulness of these materials.

A number of important factors must be considered in order to produce flexible magnetic sheets containing printable surfaces, such as, material compositions, including cost/ease of production, compatibility of flexible magnetizable sheets in combination with current industry-standard paper printing techniques (including the stability of materials during printing), and the in-service durability of resulting products after distribution. Each of these factors represents a technical challenge to be resolved to develop viable magnetizable-printable commercial products. Development of a system responding to the lack of existing processes capable of low-cost high-volume production of magnetizable writable sheet materials, using essentially “raw” material inputs, would benefit many.

### OBJECTS AND FEATURES OF THE INVENTION

A primary object and feature of the present invention is to provide a system overcoming the above-mentioned technical challenges and which responds to the lack of existing processes capable of low-cost high-volume production of “ready-to-use” magnetizable writable sheet materials, using essentially “raw” material inputs. An additional object and feature of the present invention is to provide such a system comprising a continuous-flow production process structured and arranged to produce at least one magnetizable writable sheet in a single continuous-flow production process. A further object and feature of the present invention is to provide such a system wherein such continuous-flow production of the at least one magnetizable writable sheet utilizes at least one flexible magnetizable material combined with at least one second flexible material capable of forming at least one indicia-accepting surface. Another object and feature of the present invention is to provide such a system wherein such continuous-flow production of the at least one magnetizable writable sheet utilizes specific combinations of extrusion and/or calendering processes.

A further primary object and feature of the present invention is to provide such a system that is efficient, inexpensive, and useful. Other objects and features of this invention will become apparent with reference to the following descriptions.

### SUMMARY OF THE INVENTION

In accordance with a preferred embodiment hereof, this invention provides a system, relating to continuous-flow production of at least one magnetizable writable sheet comprising at least one flexible magnetizable material and at least one second flexible material capable of forming at least one indicia-accepting surface, such system comprising: a continuous-flow production process structured and arranged to produce the at least one magnetizable writable sheet in a single continuous-flow production process; wherein such continuous-flow production process comprises at least one first material receiver structured and arranged to receive at least one raw-material input of the at least one flexible magnetizable material, at least one second material receiver structured and arranged to receive at least one second material input of the at least one second flexible material, at least one magnetizable sheet-portion former structured and arranged to form at least one magnetizable sheet portion, of the at least one magnetizable writable sheet, from the at least one first raw-material input of the at least one flexible magnetizable material, and at least one magnetizable sheet-portion modifier structured and arranged to modify the at least one magnetizable sheet-portion to comprise the at least one indicia-accepting surface; wherein such at least one magnetizable sheet-portion modifier comprises at least one material integrator structured and arranged to integrate the at least one second flexible material with the at least one magnetizable sheet-portion; and wherein such continuous-flow production process structured and arranged to produce the at least one magnetizable writable sheet in a single continuous-flow production process is provided. Moreover, it provides such a system wherein such at least one first material receiver comprises at least one pre-mixer structured and arranged to premix at least one flexible binding material with at least one magnetizable material to produce the at least one first raw-material input of the at least one flexible magnetizable material.

Additionally, it provides such a system further comprising: at least one indicia-accepting sheet-portion former structured and arranged to form at least one indicia-accepting sheet portion from the at least one second flexible material; wherein such at least one material integrator comprises at least one positioner structured and arranged to position the at least one magnetizable sheet-portion adjacent to and in contact with the at least one indicia-accepting sheet portion, and at least one sheet-portion fuser structured and arranged to fuse together the at least one magnetizable sheet-portion and the at least one indicia-accepting sheet portion. Also, it provides such a system wherein such at least one magnetizable sheet-portion former comprises at least one magnetizable sheet-portion calender structured and arranged to form the at least one magnetizable sheet-portion using at least one calendering process.

In addition, it provides such a system further comprising: at least one co-extruder structured and arranged to contemporaneously extrusion form the at least one magnetizable sheet portion from the at least one first raw-material input and at least one indicia-accepting sheet portion from the at least one second material input of the at least one second flexible material; wherein such at least one material integrator comprises at least one sheet-portion fuser structured and arranged to fuse together the at least one magnetizable sheet-portion and the at least one indicia-accepting sheet portion; and such at least one sheet-portion fuser means common die tool means for physically integrating the at least one magnetizable sheet portion and the at least one indicia-accepting sheet portion in a common die tool. And, it provides such a system wherein such at least one magnetizable sheet-portion former comprises at least one first extruder structured and arranged to extrusion form the at least one magnetizable sheet portion from the at least one first raw-material input of the at least one flexible magnetizable material.

Further, it provides such a system wherein such at least one indicia-accepting sheet-portion former comprises at least one second extruder structured and arranged to extrusion form the at least one indicia-accepting sheet portion from the at least one second flexible material. Even further, it provides such a system wherein such at least one indicia-accepting sheet-portion former comprises at least one indicia-accepting sheet-portion calender structured and arranged to form the at least one indicia-accepting sheet-portion using at least one calendering process. Moreover, it provides such a system wherein: such at least one second material receiver comprises at least one pre-formed material receiver structured and arranged to receive the at least one second flexible material in the form of at least one pre-formed indicia-accepting sheet; such at least one material integrator comprises at least one positioner structured and arranged to position the at least one magnetizable sheet-portion adjacent to and in contact with the preformed indicia-accepting sheet, and at least one sheet-portion fuser structured and arranged to fuse together the at least one magnetizable sheet-portion and the preformed indicia-accepting sheet.

Additionally, it provides such a system wherein such at least one pre-formed material receiver is configured to receive the preformed indicia-accepting sheet comprising at least one paper material. Also, it provides such a system further comprising at least one surface finishing tool structured and arranged to surface finish at least the at least one indicia-accepting sheet portion to form the at least one indicia-accepting surface. In addition, it provides such a system wherein such at least one indicia-accepting sheet-portion former comprises at least one second extruder structured and arranged to extrusion form the at least one indicia-accepting sheet portion from the at least one second flexible material. And, it provides such a system wherein: such at least one sheet-portion fuser comprises at least one compressor structured and arranged to provide compression-assisted fusing of the at least one magnetizable sheet-portion and the at least one indicia-accepting sheet portion; and, such at least one compressor comprises at least one pre-set temperature maintainer structured and arranged to assist maintaining the at least one magnetizable sheet-portion and the at least one indicia-accepting sheet portion at about at least one pre-set temperature during such compression-assisted fusing.

Further, it provides such a system further comprising at least one extrudate calender structured and arranged to calender extrudates of such at least one first extruder and such at least one second extruder. Even further, it provides such a system wherein such at least one magnetizable sheet-portion former comprises at least one magnetizable sheet-portion calender structured and arranged to form the at least one magnetizable sheet-portion using at least one calendering process. Moreover, it provides such a system wherein: such at least one sheet-portion fuser comprises at least one compressor structured and arranged to provide compression-assist fusing of the at least one magnetizable sheet-portion and the at least one indicia-accepting sheet portion; and such at least one compressor comprises at least one pre-set temperature maintainer structured and arranged to assist maintaining the at least one magnetizable sheet-portion and the at least one indicia-accepting sheet portion at about at least one pre-set temperature during such compression-assisted fusing. Additionally, it provides such a system wherein such at least one sheet-portion fuser comprises such at least one magnetizable sheet-portion calender.

Also, it provides such a system wherein such at least one magnetizable sheet-portion former comprises at least one magnetizable sheet-portion calender structured and arranged to form the at least one magnetizable sheet-portion using at least one calendering process. In addition, it provides such a system wherein such at least one sheet-portion fuser comprises such at least one magnetizable sheet-portion calender. And, it provides such a system wherein: such at least one sheet-portion fuser comprises at least one compressor structured and arranged to provide compression-assisted fusing of the at least one magnetizable sheet-portion and the at least one indicia-accepting sheet portion; and, such at least one compressor comprises pre-set temperature maintainer means for assisting maintaining the at least one magnetizable sheet-portion and the at least one indicia-accepting sheet portion at about at least one pre-set temperature during such compression-assisted fusing.

In accordance with another preferred embodiment hereof, this invention provides a system, relating to continuous-flow production of at least one magnetizable writable sheet comprising at least one flexible magnetizable material and at least one second flexible material capable of forming at least one indicia-accepting surface, such system comprising: continuous-flow production process means for producing the at least one magnetizable writable sheet in a single continuous-flow production process; wherein such continuous-flow production process means comprises first material receiver means for receiving at least one raw-material input of the at least one flexible magnetizable material, second material receiver means for receiving at least one second material input of the at least one second flexible material, magnetizable sheet-portion former means for forming at least one magnetizable sheet portion, of the at least one magnetizable writable sheet, from the at least one first raw-material input of the at least one flexible magnetizable material, and magnetizable sheet-portion modifier means for modifying the at least one magnetizable sheet-portion to comprise the at least one indicia-accepting surface; wherein such magnetizable sheet-portion modifier means comprises material integrator means for physically integrating the at least one second flexible material with the at least one magnetizable sheet-portion; and wherein the at least one magnetizable writable sheet is produced by such single continuous-flow production process. Further, it provides such a system wherein such first material receiver means comprises pre-mixer means for premixing at least one flexible binding material with at least one magnetizable material to produce the at least one first raw-material input of the at least one flexible magnetizable material.

Even further, it provides such a system further comprising: indicia-accepting sheet-portion former means for forming at least one indicia-accepting sheet portion from the at least one second flexible material; wherein such material integrator means comprises positioner means for positioning the at least one magnetizable sheet-portion adjacent to and in contact with the at least one indicia-accepting sheet portion, and, sheet-portion fuser means for fusing together the at least one magnetizable sheet-portion and the at least one indicia-accepting sheet portion. Moreover, it provides such a system wherein such magnetizable sheet-portion former means comprises magnetizable sheet-portion calender means for forming the at least one magnetizable sheet-portion using at least one calendering process. Additionally, it provides such a system further comprising: co-extruder means for contemporaneously extrusion forming the at least one magnetizable sheet portion from the at least one first raw-material input and at least one indicia-accepting sheet portion from the at least one second material input of the at least one second flexible material; wherein such material integrator means comprises sheet-portion fuser means for fusing together the at least one magnetizable sheet-portion and the at least one indicia-accepting sheet portion; and such sheet-portion fuser means comprises common die tool means for physically integrating the at least one magnetizable sheet portion and the at least one indicia-accepting sheet portion in a common die tool. Also, it provides such a system wherein such magnetizable sheet-portion former means comprises first extruder means for extrusion forming the at least one magnetizable sheet portion from the at least one first raw-material input of the at least one flexible magnetizable material.

In addition, it provides such a system wherein such indicia-accepting sheet-portion former means comprises second extruder means for extrusion forming the at least one indicia-accepting sheet portion from the at least one second flexible material. And, it provides such a system wherein such indicia-accepting sheet-portion former means comprises indicia-accepting sheet-portion calender means for forming the at least one indicia-accepting sheet-portion using at least one calendering process. Further, it provides such a system wherein: such second material receiver means comprises pre-formed material receiver means for receiving the at least one second flexible material in the form of at least one pre-formed indicia-accepting sheet; such material integrator means comprises positioner means for positioning the at least one magnetizable sheet-portion adjacent to and in contact with the preformed indicia-accepting sheet, and, sheet-portion fuser means for fusing together the at least one magnetizable sheet-portion and the preformed indicia-accepting sheet. Even further, it provides such a system wherein such pre-formed material receiver means is configured to receive the preformed indicia-accepting sheet comprising at least one paper material.

Moreover, it provides such a system further comprising surface finishing tool means for surface finishing at least the at least one indicia-accepting sheet portion to form the at least one indicia-accepting surface. Additionally, it provides such a system wherein such indicia-accepting sheet-portion former means comprises second extruder means for extrusion forming the at least one indicia-accepting sheet portion from the at least one second flexible material. Also, it provides such a system wherein: such sheet-portion fuser means comprises compressor means for compression-assisted fusing of the at least one magnetizable sheet-portion and the at least one indicia-accepting sheet portion; and such compressor means comprises pre-set temperature maintainer means for assisting maintaining the at least one magnetizable sheet-portion and the at least one indicia-accepting sheet portion at about at least one pre-set temperature during such compression-assisted fusing. In addition, it provides such a system further comprising extrudate calender means for calendering extrudates of such first extruder means and such second extruder means. And, it provides such a system wherein such magnetizable sheet-portion former means comprises magnetizable sheet-portion calender means for forming the at least one magnetizable sheet-portion using at least one calendering process.

Further, it provides such a system wherein: such sheet-portion fuser means comprises compressor means for compression-assisted fusing of the at least one magnetizable sheet-portion and the at least one indicia-accepting sheet portion; and such compressor means comprises pre-set temperature maintainer means for assisting maintaining the at least one magnetizable sheet-portion and the at least one indicia-accepting sheet portion at about at least one pre-set temperature during such compression-assisted fusing. Even further, it provides such a system wherein such sheet-portion fuser means comprises such magnetizable sheet-portion calender means. Even further, it provides such a system wherein such magnetizable sheet-portion former means comprises magnetizable sheet-portion calender means for forming the at least one magnetizable sheet-portion using at least one calendering process. Even further, it provides such a system wherein such sheet-portion fuser means comprises such magnetizable sheet-portion calender means. Even further, it provides such a system wherein: such sheet-portion fuser means comprises compressor means for compression-assisted fusing of the at least one magnetizable sheet-portion and the at least one indicia-accepting sheet portion; and, such compressor means comprises pre-set temperature maintainer means for assisting maintaining the at least one magnetizable sheet-portion and the at least one indicia-accepting sheet portion at about at least one pre-set temperature during such compression-assisted fusing.

In accordance with another preferred embodiment hereof, this invention provides a system, relating to manufacturing at least one flexible magnetizable sheet from at least one magnetizable sheet-portion, having at least one mixture of at least one flexibly-binding material and at least one magnetizable material, and from at least one indicia-accepting sheet-portion, in a single continuous process, comprising: continuous sheet shaper means for continuously shaping the at least one flexible magnetizable sheet; wherein such sheet shaper means comprises magnetizable sheet-portion shaper means for shaping the at least one mixture of the at least one flexibly-binding material and the at least one magnetizable material into the at least one magnetizable sheet-portion, indicia-accepting sheet-portion feeder means for feeding the at least one indicia-accepting sheet-portion through such magnetizable sheet-portion shaper means, and wherein such indicia-accepting sheet-portion feeder means comprises positioner means for positioning the at least one magnetizable sheet-portion adjacent to and in contact with the at least one indicia-accepting sheet-portion, sheet-portion bonder means for bonding the at least one magnetizable sheet-portion and the at least one indicia-accepting sheet-portion; wherein such sheet-portion bonder means comprises contacting-surface intermingler means for intermingling in-contact surfaces of the at least one magnetizable sheet-portion and the at least one indicia-accepting sheet-portion; sheet cooling means for cooling the at least one flexible magnetizable sheet after such bonding; wherein such system forms the at least one flexible magnetizable sheet in a single continuous process.

In accordance with another preferred embodiment hereof, this invention provides a method, relating to continuous-flow production of at least one magnetizable writable sheet comprising at least one flexible magnetizable material and at least one second flexible material capable of forming at least one indicia-accepting surface, such method comprising the steps of: providing at least one first material receiver structured and arranged to receive at least one raw-material input of the at least one flexible magnetizable material; providing at least one second material receiver structured and arranged to receive at least one second material input of the at least one second flexible material; providing at least one magnetizable sheet-portion former structured and arranged to form at least one magnetizable sheet portion, of the at least one magnetizable writable sheet, from the at least one first raw-material input of the at least one flexible magnetizable material; and providing at least one magnetizable sheet-portion modifier structured and arranged to modify the at least one magnetizable sheet-portion to comprise the at least one indicia-accepting surface; providing within such at least one magnetizable sheet-portion modifier, at least one material integrator structured and arranged to integrate the at least one second flexible material with the at least one magnetizable sheet-portion; wherein such continuous-flow production process structured and arranged to produce the at least one magnetizable writable sheet in a single continuous-flow production process is provided.

In accordance with embodiments hereof, this invention further provides for each and every novel feature, element, combination, step and/or method disclosed or suggested by this patent application.

### BRIEF DESCRIPTION OF THE DRAWINGS

FIG. 1 shows a diagrammatic depiction, illustrating a continuous-flow production process to produce at least one magnetizable writable sheet, according to a preferred embodiment of the present invention.

FIG. 2 shows a diagrammatic sectional view, illustrating the multi-layered arrangement of the magnetizable writable sheet produced by the single continuous-flow production process, according to the preferred embodiments of the present invention.

FIG. 3 shows a diagrammatic depiction, illustrating an alternate continuous-flow production process to produce the at least one magnetizable writable sheet, in a single continuous-flow production process, by pre-mixing raw-material components to produce at least one first raw-material input, according to another preferred embodiment of the present invention.

FIG. 4 shows a diagrammatic depiction, illustrating a continuous-flow production process, utilizing an indicia-accepting sheet-portion former to form at least one indicia-accepting sheet portion from at least one second flexible material, to another preferred embodiment of the present invention.

FIG. 5 shows a diagrammatic depiction, illustrating a continuous-flow production process, utilizing at least one co-extruder to contemporaneously extrusion form the at least one magnetizable sheet portion and at least one indicia-accepting sheet portion, according to another preferred embodiment of the present invention.

FIG. 6 shows a diagrammatic depiction, illustrating another continuous-flow production process, utilizing at least one co-extruder in combination with at least one surface-finishing tool structured and arranged to form at least one indicia-accepting surface, according to another preferred embodiment of the present invention.

FIG. 7 shows a diagrammatic depiction, illustrating another continuous-flow production process, utilizing at least one first extruder to extrusion form the at least one magnetizable sheet portion and at least one second extruder to extrusion form the at least one indicia-accepting sheet portion, including an additional finishing process, according to additional preferred embodiments of the present invention.

FIG. 8 shows a diagrammatic depiction, illustrating another continuous-flow production process, utilizing at least one magnetizable sheet-portion calender, at least one indicia-accepting sheet-portion calender, and at least one fusing process, according to additional preferred embodiments of the present invention.

FIG. 9 shows a diagrammatic depiction, illustrating another continuous-flow production process, utilizing at least one magnetizable sheet-portion calender, at least one indicia-accepting sheet-portion calender, wherein the magnetizable sheet-portion calender functions to fuse the magnetizable sheet-portion and indicia-accepting sheet-portion, according to additional preferred embodiments of the present invention.

FIG. 10 shows a diagrammatic depiction, illustrating another continuous-flow production process, utilizing at least one magnetizable sheet-portion calender in combination with an extruder to extrusion form the at least one indicia-accepting sheet portion, according to additional preferred embodiments of the present invention.

FIG. 11 shows a diagrammatic depiction, illustrating another continuous-flow production process, utilizing at least one magnetizable sheet-portion calender in combination with an extruder to extrusion form the at least one indicia-accepting sheet portion, including an additional fusing process, according to additional preferred embodiments of the present invention.

FIG. 12 shows a diagrammatic depiction, illustrating another continuous-flow production process, utilizing an input of at least one second flexible material, in the form of at least one pre-formed indicia-accepting sheet, and at least one magnetizable sheet-portion calender utilized to form the at least one magnetizable sheet-portion and contemporaneously integrate the pre-formed indicia-accepting sheet, according to additional preferred embodiments of the present invention.

FIG. 13 shows a flow diagram illustrating a preferred method enabling the continuous-flow production processes of the present invention.

FIG. 14 shows a diagrammatic depiction of another continuous-flow production process, utilizing at least one magnetizable sheet-portion calender and at least one indicia-accepting sheet-portion calender, wherein the magnetizable sheet-portion calender functions to fuse the magnetizable sheet-portion and indicia-accepting sheet-portion, according to additional preferred embodiments of the present invention.

FIG. 15 shows another diagrammatic depiction of a continuous-flow production process, utilizing at least one sheet coater, according to additional preferred embodiments of the present invention.

### DETAILED DESCRIPTION OF THE BEST MODES AND PREFERRED EMBODIMENTS OF THE INVENTION

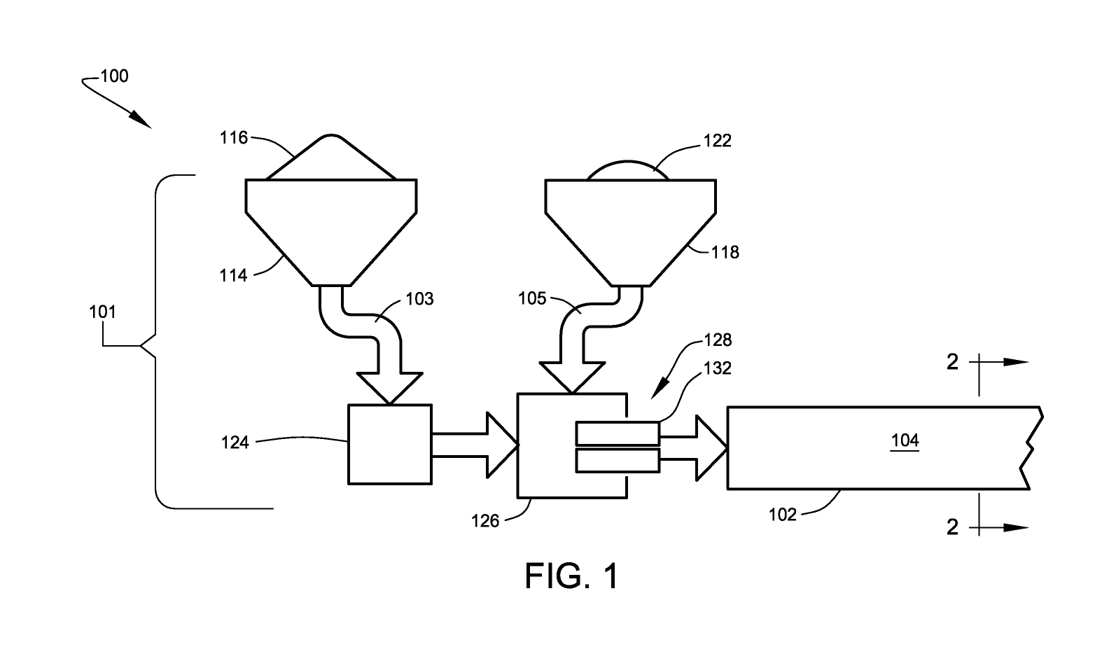

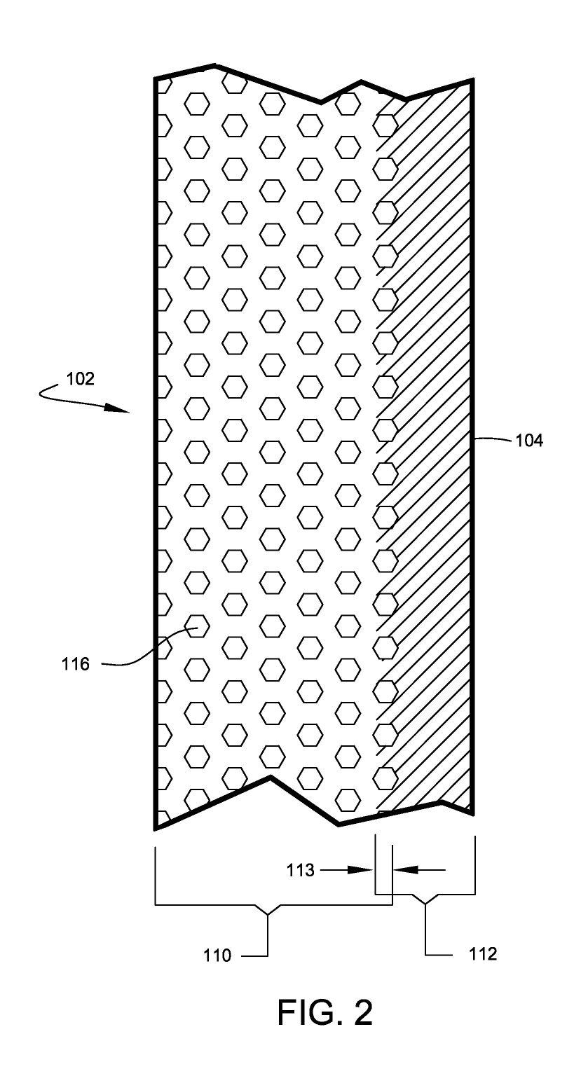

FIG. 1 shows a diagrammatic depiction, illustrating a preferred continuous-flow production process 101 enabling the generation of “ready-to-use” magnetizable writable sheet(s) 102 from at least one first raw-material input 103 and at least one second material input 105, according to preferred embodiments of the present invention. FIG. 2 shows a diagrammatic sectional view, through the section 2-2 of FIG. 1, illustrating the preferred multi-layered arrangement of magnetizable writable sheet 102 preferably produced by continuous-flow production process 101 shown in FIG. 1.

Applicant's continuous-flow production process 101 (at least embodying herein continuous-flow production process means for producing the at least one magnetizable writable sheet in a single continuous-flow production process) is preferably designed to efficiently transform input resources into “ready-to-use” finished goods. Applicant's preferred continuous-flow production process 101 was developed in response to the lack of existing processes capable of providing low-cost high-volume production of magnetizable writable sheet material preferably using at least one raw-material input 103 and at least one second material input 105.

In reference to the sectional illustration of FIG. 2, one highly preferred configuration of magnetizable writable sheet 102 comprises at least one magnetizable sheet-portion 110 preferably modified to include a face lamina identified herein as indicia-accepting sheet-portion 112. In this preferred arrangement, indicia-accepting sheet-portion 112 preferably comprises an outer indicia-accepting surface 104, as shown. This outer indicia-accepting surface 104 is preferably configured to be compatible with one or more printing processes, most preferably one or more conventional machine-assisted printing processes. It is noted that preferred embodiments of indicia-accepting surface 104 are further preferably configured to receive hand-writing and similar indicia.

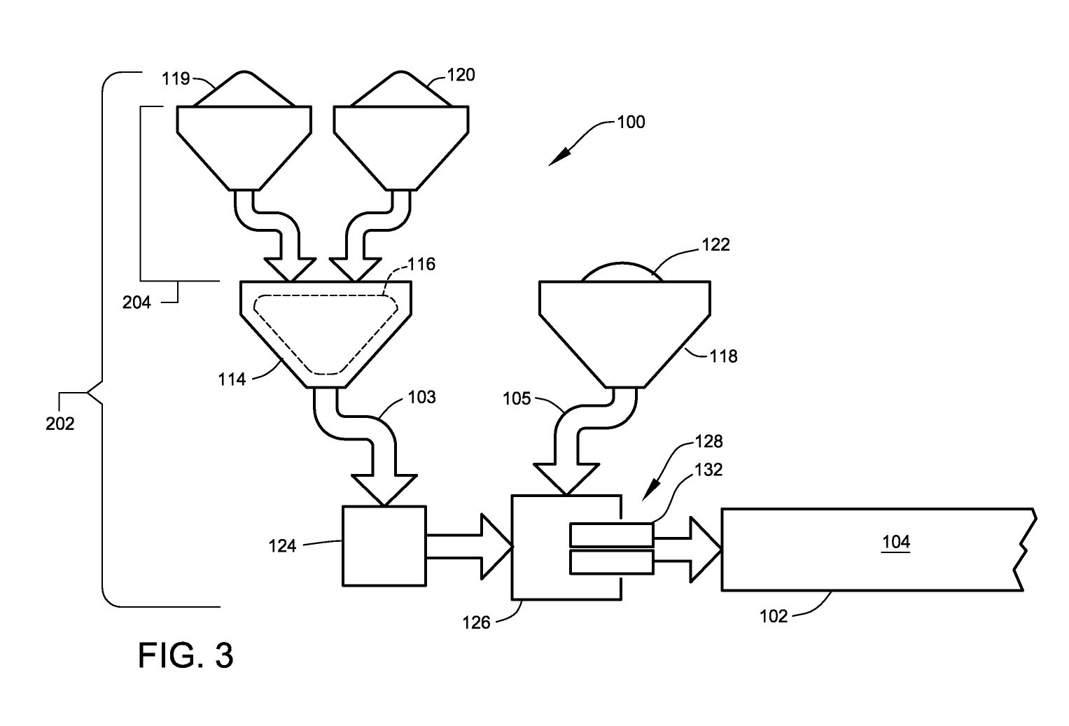

Magnetizable sheet-portion 110 preferably comprises at least one flexible magnetizable material 116, preferably allowing magnetization of magnetizable writable sheet 102 by an external magnetic field (such material preferably remaining magnetized after the external field is removed). Preferred flexible magnetizable materials 116 preferably comprise a homogenous mixture of ferrous particles 119 and at least one binding material 120 (see FIG. 3). Such binding material 120 preferably imparts to magnetizable writable sheet 102 at least the properties of shape retention and flexibility.

Ferrous particles 119 comprise preferably ferrite particles, preferably strontium ferrite particles (SrFe₁₂O₁₉). Ferrous particles 119 preferably comprise less than about 20 nanometers each in diameter. Upon reading this specification, those skilled in the art will now appreciate that, under appropriate circumstances, considering such issues as cost, available materials, etc., other than ferrous particles exhibiting magnetic qualities, such as, for example, Heusler alloys, lanthanide elements, as of yet formulated ferromagnetic compositions (which can be magnetized by an external magnetic field and which remain magnetized after the external field is removed), etc., may suffice.

Indicia-accepting sheet-portion 112 preferably comprises at least one polymer, preferably at least one poly-vinyl. Alternately preferably, indicia-accepting sheet-portion 112 comprises paper.

Where such magnetizable materials generally darken the coloring of magnetizable sheet-portion 110, to a point where most writing or marking is made indistinguishable, indicia-accepting sheet-portion 112 preferably provides a lightened surface coloring, preferably enabling such writing or such marking to be clearly distinguishable on the outer sheet surface.

Indicia-accepting sheet-portion 112 and magnetizable sheet-portion 110 are preferably bound together in such manner as to form an indivisible sheet structure. More specifically, a portion of the constituent materials of indicia-accepting sheet-portion 112 and a portion of the constituent materials of magnetizable sheet-portion 110 preferably co-mingle at a common fusion region 113, as shown.

When indicia-accepting sheet-portion 112 comprises a polymer, such co-mingling preferably occurs between such polymer of indicia-accepting sheet-portion 112 and the polymer of such binding material in magnetizable sheet-portion 110. Such polymer of indicia-accepting sheet-portion 112 and the polymer of such at least one binding material in magnetizable sheet-portion 110 preferably is compatible, and preferably is capable of, mixing and preferably forming at least one material fusion bond.

When indicia-accepting sheet-portion 112 comprises paper, such co-mingling preferably occurs between the paper of indicia-accepting sheet-portion 112 and the polymer of such binding material in magnetizable sheet-portion 110. The polymer of such at least one binding material in magnetizable sheet-portion 110 preferably is compatible with paper, and preferably is capable of being absorbed into such paper and preferably forming a material fusion bond.

Magnetizable sheet-portion 110 preferably comprises a thickness of from about 5 mils (about 0.13 millimeters) to about 20 mils (about 0.51 millimeters), preferably less than about 15 mils (about 0.38 millimeters). Indicia-accepting sheet-portion 112 preferably comprises a thickness of from about 1 mil (about 0.03 millimeters) to about 3 mils (about 0.08 millimeters), preferably about 2 mils (about 0.05 millimeters). Writable magnetic sheet 102 preferably comprises a thickness of from about 7 mils (about 0.018 millimeters) to about 25 mils (about 0.63 millimeters), preferably less than about 15 mils (about 0.38 millimeters).

Magnetizable sheet-portion 110 preferably comprises about 91% of such at least one magnetizable material and about 9% of such at least one binding material, by weight. Such binding material preferably comprises at least one polymer. Preferred polymers include Hypalon 45 (chlorosulfonated polyethylene rubber), alternately preferably polyisobutylene (—(CH2-C3H6)n-), and alternately preferably ethylene vinyl acetate (CH3COOCH=CH2). Upon reading this specification, those with ordinary skill in the art will now appreciate that, under appropriate circumstances, considering such issues as design preference, user preferences, marketing preferences, cost, structural requirements, available materials, technological advances, etc., other material percentage arrangements such as, for example, greater or lesser material percentages, etc., may suffice.

By weight of such binding material: Hypalon 45 preferably comprises about 3.6%; polyisobutylene preferably comprises about 3%; and ethylene vinyl acetate preferably comprises about 2.2%. Upon reading this specification, those skilled in the art will now appreciate that, under appropriate circumstances, considering such issues as cost, future technology, etc., other binder materials, such as, for example, resins, other plastics, etc., may suffice.

Referring again to the diagram of FIG. 1, continuous-flow production process 101 preferably comprises at least two separate material inputs associated respectively with the production of magnetizable sheet-portion 110 and indicia-accepting sheet-portion 112. In that regard, continuous-flow production process 101 preferably comprises at least one first material receiver 114 and at least one second material receiver 118, as shown.

First material receiver 114 is preferably configured to receive raw-material input 103 of flexible magnetizable material 116 (at least embodying herein first material receiver means for receiving at least one raw-material input of the at least one flexible magnetizable material). Second material receiver 118 is preferably configured to receive a second material input 105 of second flexible material 122 preferably designated to form indicia-accepting sheet-portion 112 (at least embodying, herein second material receiver means for receiving at least one second material input of the at least one second flexible material). Thus, second flexible material 122 is preferably selected to possess indicia-accepting surface 104 or, alternately preferably, preferably is capable of forming the indicia-accepting surface 104 illustrated in FIG. 2.

As previously noted, indicia-accepting sheet-portion 112 preferably comprises a polymer or, alternately preferably, a cellulose-containing paper material. Second flexible material 122 is preferably supplied in substantially a raw-material form when second flexible material 122 comprises a synthetic polymer. Conversely, second flexible material 122 is preferably supplied as a pre-formed sheet when the second flexible material 122 comprises paper. Upon reading this specification, those with ordinary skill in the art will now appreciate that, under appropriate circumstances, considering such issues as cost, user preference, advances in material technology, advances in printing technology, etc., other materials and arrangements such as, for example, surface finishing of partially formed cellulose-based sheets, use of multi-component printable sheet materials, etc., may suffice.

Continuous-flow production process 101 preferably includes at least one magnetizable sheet-portion former 124 structured and arranged to form magnetizable sheet-portion 110 from the first raw-material input 103 of flexible magnetizable material 116 (at least embodying herein magnetizable sheet-portion former means for forming at least one magnetizable sheet portion, of the at least one magnetizable writable sheet, from the at least one first raw-material input of the at least one flexible magnetizable material). Subsequent teachings of the present disclosure will elaborate on preferred structures and processes associated the formation of magnetizable sheet-portion 110 by magnetizable sheet-portion former 124.

The output of magnetizable sheet-portion former 124 preferably passes to at least one magnetizable sheet-portion modifier 126 of continuous-flow production process 101, as shown. Magnetizable sheet-portion modifier 126 is preferably configured to modify magnetizable sheet-portion 110 to comprise the indicia-accepting surface 104, most preferably by the physical integration of the two sheet portions noted above (at least embodying herein magnetizable sheet-portion modifier means for modifying the at least one magnetizable sheet-portion to comprise the at least one indicia-accepting surface). Such integration is preferably enabled by the preferred establishment of material integrator 128 within the production processes associated with magnetizable sheet-portion modifier 126. In that regard, material integrator 128 is preferably structured and arranged to provide a physical integration of the second flexible material 122 of indicia-accepting sheet-portion 112 with the flexible magnetizable material 116 of magnetizable sheet-portion 110 (at least embodying herein wherein such magnetizable sheet-portion modifier means comprises material integrator means for physically integrating the at least one second flexible material with the at least one magnetizable sheet-portion). Material integrator 128 is preferably configured to position magnetizable sheet-portion 110 adjacent to and in contact with indicia-accepting sheet-portion 112 during the material integration portion of the process. Material integrator 128 preferably utilizes a material fusion process to co-mingle magnetizable sheet-portion 110 with indicia-accepting sheet-portion 112 at fusion region 113 (see FIG. 2). Such material fusion process is preferably accomplished by at least one sheet-portion fuser 132, preferably embedded within structured and arranged to fuse together the at least one magnetizable sheet-portion and the at least one indicia-accepting sheet portion

Subsequent teachings of the present disclosure will elaborate on preferred structures and processes associated such material integration processes.

FIG. 3 shows a diagrammatic depiction, illustrating an alternate continuous-flow production process 202, of writable magnetic sheet system 100, according to another preferred embodiment of the present invention. It is noted that alternate continuous-flow production process 202 comprises process arrangements substantially similar to continuous-flow production process 101 of FIG. 1; thus, only the differences between alternate continuous-flow production process 202 and the prior embodiment will be elaborated upon below.

Alternate continuous-flow production process 202 is preferably structured and arranged to produce magnetizable writable sheet 102, in a single continuous-flow production process, preferably by first premixing a selected set of raw-material components to produce raw-material input 103. In one highly preferred arrangement of the present system, such selected set of raw-material components preferably comprise ferrous particles 119 and binding material 120, as shown. Preferably, alternate continuous-flow production process 202 comprises an additional premix stage 204 wherein such ferrous particles 119 and binding material 120 are preferably combined to form flexible magnetizable material 116, as shown. The resulting output, of flexible magnetizable material 116, preferably forms the preferred input of first material receiver 114.

Subsequent production processes of alternate continuous-flow production process 202 preferably follow those of continuous-flow production process 101. Upon reading this specification, those with ordinary skill in the art will now appreciate that, under appropriate circumstances, considering such issues as cost, production requirements, etc., additional pre-mixing provisions such as, for example, the use of apparatus/components supporting mixing, blending, and/or beneficial dispersion of materials, automated control/measurement steps, testing/sampling, binder melting steps, etc., may suffice.

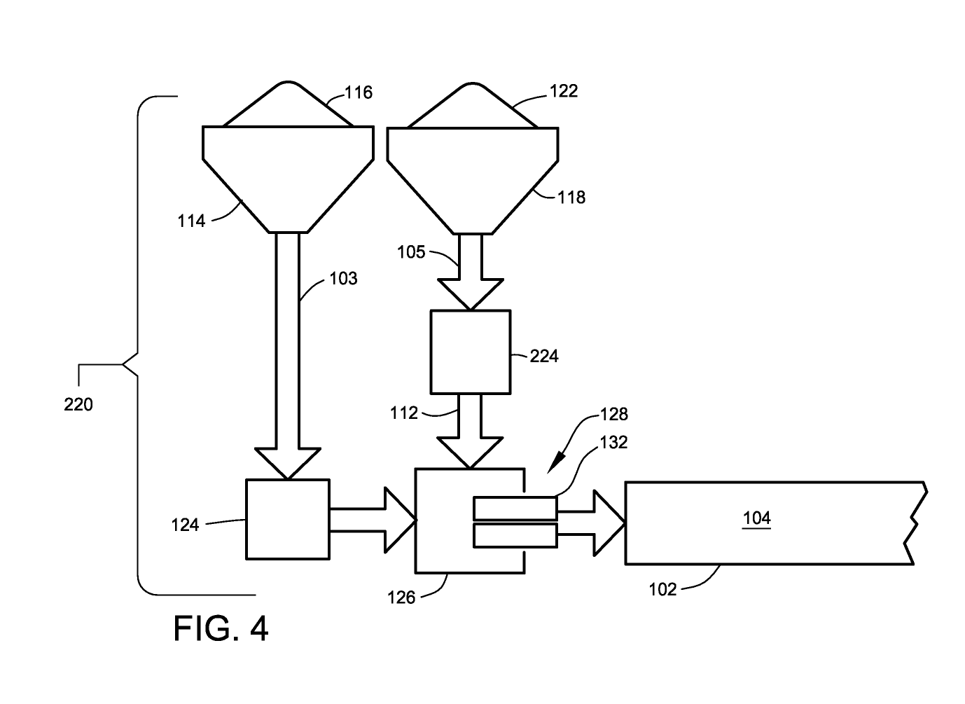

FIG. 4 shows a diagrammatic depiction, illustrating alternate continuous-flow production process 220, of writable magnetic sheet system 100, according to another preferred embodiment of the present invention. It is noted that alternate continuous-flow production process 220 comprises process arrangements substantially similar to continuous-flow production process 101 of FIG. 1; thus, only the differences between alternate continuous-flow production process 220 and the prior embodiment will be elaborated upon.

Alternate continuous-flow production process 220 preferably utilizes an additional indicia-accepting sheet-portion former 224 preferably structured and arranged to form indicia-accepting sheet-portion 112, from second flexible material 122, as shown. Subsequent production processes of alternate continuous-flow production process 220 preferably follow those of continuous-flow production process 101. Subsequent teachings of the present disclosure will elaborate on preferred structures and processes associated indicia-accepting sheet-portion former 224.

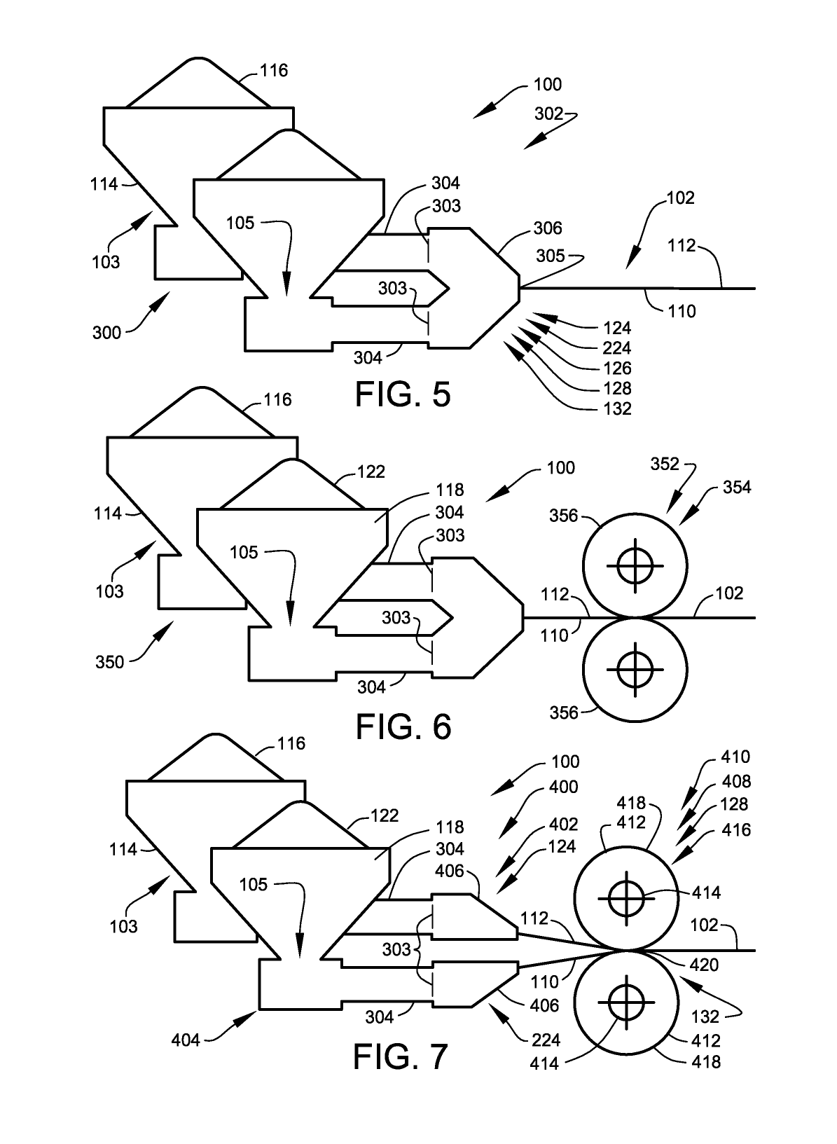

FIG. 5 through FIG. 12 illustrate preferred implementations of the above-described continuous-flow production processes of writable magnetic sheet system 100. As noted above, each of Applicant's described production processes are preferably designed to efficiently transform a set of input resources into the “ready-to-use” magnetizable writable sheet(s) 102 as generally depicted in FIG. 2 and described herein.

FIG. 5 shows a diagrammatic depiction, illustrating continuous-flow production process 300, according to another preferred embodiment of the present invention. Continuous-flow production process 300 preferably forms the “ready-to-use” magnetizable writable sheet 102 using at least one co-extrusion process. Formation of magnetizable writable sheet 102 by such preferred co-extrusion process is preferably enabled by the implementation of at least one co-extrusion apparatus assembly 302 within continuous-flow production process 300, as shown. Such co-extrusion apparatus assembly 302 is preferably configured to form magnetizable writable sheet 102 by the contemporaneous extrusions and fusion integration of magnetizable sheet portion 110 and indicia-accepting sheet portion 112 (at least embodying herein at least one co-extruder structured and arranged to contemporaneously extrusion form the at least one magnetizable sheet portion from the at least one first raw-material input and at least one indicia-accepting sheet portion from the at least one second material input of the at least one second flexible material).

Continuous-flow production process 300 is capable high levels of production efficiency by combining, in a single process step, contemporaneous formation of magnetizable sheet portion 110 and indicia-accepting sheet-portion 112 along with contemporaneous integration/fusion of the two sheet-portions concurrently with their formation. More specifically, co-extrusion apparatus assembly 302 preferably combines the functions of magnetizable sheet-portion former 124, indicia-accepting sheet-portion former 224, magnetizable sheet-portion modifier 126, material integrator 128, and sheet-portion fuser 132.

Co-extrusion apparatus assembly 302 preferably comprises two feed channels 304, one preferably configured to receive flexible magnetizable material 116 from first material receiver 114 and one preferably configured to receive second flexible material 122 from second material receiver 118. Each feed channel 304 is preferably configured to convey a respective feed material to co-extrusion die 306, as shown. In one preferred arrangement of the presently-described embodiment, each feed channel 304 contains a rotating screw preferably configured to force the respective material forward into co-extrusion die 306. In such a system, each feed channel 304 is preferably heated to the desired melt temperature of the selected polymer-based material. In a preferred arrangement of the present system, a screen assembly 303 is preferably placed between feed channel 304 and co-extrusion die 306 to filter out contaminants and to maintain back pressure within the channel. Such back pressure is preferably used to promote uniform melting and proper mixing of the polymer-based materials. The level of back pressure within feed channel 304 can be modulated preferably by varying the speed of the rotating screw and/or configuration of screen assembly 303.

Co-extrusion die 306 preferably extrudes magnetizable sheet-portion 110 and indicia-accepting sheet-portion 112 simultaneously, preferably from a common extrusion orifice 305 of the die tool. Extrudates of magnetizable sheet-portion 110 and indicia-accepting sheet-portion 112 preferably are integrated (fused together) before leaving co-extrusion die 306 (at least embodying herein wherein such at least one material integrator comprises at least one sheet-portion fuser structured and arranged to fuse together the at least one magnetizable sheet-portion and the at least one indicia-accepting sheet portion; and at least embodying herein such at least one sheet-portion fuser means common die tool means for physically integrating the at least one magnetizable sheet portion and the at least one indicia-accepting sheet portion in a common die tool).

FIG. 6 shows a diagrammatic depiction, illustrating alternate continuous-flow production process 350, preferably utilizing at least one surface finishing tool 352 in combination with co-extrusion apparatus assembly 302 of continuous-flow production process 300, as shown. Surface finishing tool 352 is preferably structured and arranged to assist in forming outer indicia-accepting surface 104, according to another preferred embodiment of the present invention (at least embodying herein at least one surface finishing tool structured and arranged to surface finish at least the at least one indicia-accepting sheet portion to form the at least one indicia-accepting surface).

Magnetizable writable sheet 102 exits the die in a semi-viscous state and travels through surface finishing tool 352 during cooling. Surface finishing tool 352 preferably assists in establishing final sheet thickness and width. Preferably, magnetizable writable sheet 102 may then be wound onto continuous rolls, or sheared into discrete lengths.

In one preferred arrangement of alternate continuous-flow production process 350, surface finishing tool 352 preferably comprises at least one sheet calendering process 354, as shown. Calendering process 354 preferably smoothes and compresses magnetizable writable sheet 102 after extrusion preferably by passing the continuous extruded sheet through pairs of calender rolls 356, as shown. In a highly preferred embodiment of the system, calender rolls 356 are heated. Calender rolls 356 are preferably constructed of steel with a smooth hardened surface. Magnetizable writable sheet 102 is preferably calendered post extrusion to provide a smooth, printable surface finish, as required by some printing processes. Calendering is also preferably used to establish a consistent sheet thickness, which is essential in certain printing applications.

FIG. 7 shows a diagrammatic depiction, illustrating alternate continuous-flow production process 400, according to additional preferred embodiments of the present invention. Alternate continuous-flow production process 400 preferably utilizes two independent extrusion processes to form magnetizable sheet-portion 110 and flexible magnetizable material 116. Within alternate continuous-flow production process 400, magnetizable sheet-portion former 124 preferably comprises a first sheet extruder 402 that is preferably configured to extrusion form magnetizable sheet portion 110 from raw-material input 103 of flexible magnetizable material 116, as shown (at least embodying herein wherein such at least one magnetizable sheet-portion former comprises at least one first extruder structured and arranged to extrusion form the at least one magnetizable sheet portion from the at least one first raw-material input of the at least one flexible magnetizable material). It is noted that raw-material input 103 may be produced by first premixing a selected set of raw-material components, as illustrated in FIG. 3.

Indicia-accepting sheet-portion former 224 preferably comprises a second extruder 404 structured and arranged to extrusion form indicia-accepting sheet portion 112 from second material input 105 of second flexible material 122, as shown (at least embodying herein wherein such at least one indicia-accepting sheet-portion former comprises at least one second extruder structured and arranged to extrusion form the at least one indicia-accepting sheet portion from the at least one second flexible material).

Preferably, both first extruder 402 and second extruder 404 each comprise a dedicated feed channel 304, preferably of the type generally described in the prior co-extrusion embodiment. Alternate continuous-flow production process 400 differs from the prior embodiment in that each extruder is preferably equipped with a separate sheet-forming extrusion die 406, as shown. This preferred arrangement allows magnetizable sheet portion 110 and indicia-accepting sheet portion 112 to be formed concurrently, but in separate extrusion lines. One advantage of dividing the sheet extrusion process is that separate extrusions provide added production control during design, setup, and operation of the production line.

The extruded sheets exit the dies in a semi-viscous state and are preferably transferred to a sheet-portion modifier 408 where they are combined to form magnetizable writable sheet 102, as shown. Sheet-portion modifier 408 is preferably configured to comprise the functions of material integrator 128, and sheet-portion fuser 132.

One preferred configuration of sheet-portion modifier 408 preferably comprises the use of at least one sheet compressor assembly 410 preferably structured and arranged to provide compression-assisted fusing of magnetizable sheet-portion 110 and indicia-accepting sheet portion 112. Preferably, sheet compressor assembly 410 comprises sets of heated rollers 412 through which magnetizable sheet-portion 110 and indicia-accepting sheet-portion 112 pass. During passage, the sheets are fused using pressure and heat. Heated rollers 412 preferably utilize least one pre-set temperature maintainer 414 structured and arranged to assist maintaining heated rollers 412 at about at least one pre-set temperature needed to support such compression-assisted fusing. Heated rollers 412 preferably maintain magnetizable sheet-portion 110 and indicia-accepting sheet portion 112 within the pre-set temperature range needed for proper fusion by the transfer of heat to the sheets during compression (at least embodying herein wherein such at least one sheet-portion fuser comprises at least one compressor structured and arranged to provide compression-assisted fusing of the at least one magnetizable sheet-portion and the at least one indicia-accepting sheet portion; and such at least one compressor comprises at least one pre-set temperature maintainer structured and arranged to assist maintaining the at least one magnetizable sheet-portion and the at least one indicia-accepting sheet portion at about at least one pre-set temperature during such compression-assisted fusing).

An alternate preferred configuration of sheet-portion modifier 408 preferably comprises the use of at least one extrudate calender assembly 416 structured and arranged to calender-process extrudates of first sheet extruder 402 and second sheet extruder 404. In this preferred process, magnetizable sheet-portion 110 and indicia-accepting sheet-portion 112 pass through pairs of calender rolls 418, as shown. In a highly preferred embodiment of the system, calender rolls 418 are heated to promote fusion of the sheets, preferably utilizing the above-noted pre-set temperature maintainer 414. Calender rolls 418 are preferably constructed of steel with a smooth hardened surface. Consistent sheet thickness is preferably achieved by careful management of calendering nip 420, the temperature of calender rolls 418 and the shape of calender rolls 418. Calendering nip 420 is preferably configured to maintain a consistent clearance gap between calender rolls 418, and thus may be shaped to compensate for mid-span deflection occurring under working loads. Preferably, magnetizable writable sheet 102 exits sheet-portion modifier 408 to be wound onto continuous rolls, or sheared into discrete lengths.

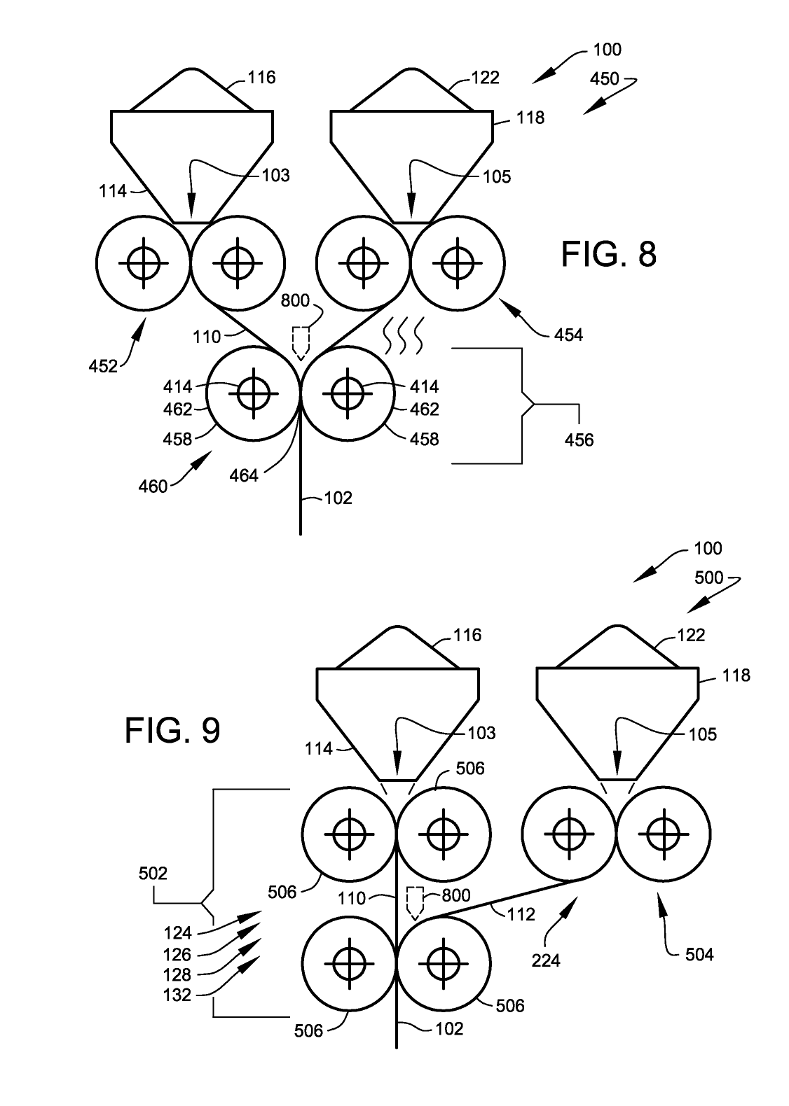

FIG. 8 shows a diagrammatic depiction, illustrating alternate continuous-flow production process 450, utilizing at least one magnetizable sheet-portion calender 452, at least one indicia-accepting sheet-portion calender 454, and at least one fusing process 456, according to additional preferred embodiments of the present invention. Magnetizable sheet-portion calender 452 is preferably configured to produce magnetizable sheet-portion 110 from raw-material input 103 of flexible magnetizable material 116. It is noted that raw-material input 103 may be produced by first premixing a selected set of raw-material components, as illustrated and described in FIG. 3. Indicia-accepting sheet-portion calender 454 is preferably configured to produce indicia-accepting sheet-portion 112 from second material input 105 of second flexible material 122, most preferably a polymer-based raw material.

As magnetizable sheet-portion 110 and indicia-accepting sheet-portion 112 are formed, both are preferably transferred to at least one fusing process 456, as shown. In one preferred embodiment of the present system, fusing process 456 preferably comprises a set of bonding rollers 458, as shown. Bonding rollers 458 preferably apply heat and pressure, preferably fusing magnetizable sheet-portion 110 and indicia-accepting sheet-portion 112 into magnetizable writable sheet 102. In a highly preferred embodiment of fusing process 456, bonding rollers 458 are preferably heated by the above-noted pre-set temperature maintainer 414 to promote fusion of the sheets. Bonding rollers 458 are preferably configured to apply even pressure and heat sufficient to fuse the sheet portions into a unitary sheet. Preferably, bonding rollers 458 are not designed to significantly alter the thickness or surface quality of the resulting magnetizable writable sheet 102.

An alternate preferred configuration of fusing process 456 preferably replaces bonding rollers 458 with at least one calender assembly 460 preferably structured and arranged to alter the thickness and surface quality of magnetizable writable sheet 102 during the fusion process. In this preferred system configuration, magnetizable sheet-portion 110 and indicia-accepting sheet-portion 112 pass through pairs of calender rolls 462, as shown. In a highly preferred embodiment of the system, calender rolls 462 are heated to promote fusion of the sheets, preferably utilizing the above-noted pre-set temperature maintainer 414. Consistent sheet thickness is preferably achieved by careful management of clearances within calendering nip 464, the temperature of calender rolls 462 and the shape of calender rolls 462. Calender assembly 460 is preferably configured to produce a sheet of uniform thickness having a surface quality preferably suitable for printing. On exiting fusing process 456, magnetizable writable sheet 102 may preferably be wound onto continuous rolls, or sheared into discrete lengths.

FIG. 9 shows a diagrammatic depiction, illustrating alternate continuous-flow production process 500, preferably utilizing at least one magnetizable sheet-portion calender 502, at least one indicia-accepting sheet-portion calender 504, wherein magnetizable sheet-portion calender 502 functions to fuse magnetizable sheet-portion 110 and indicia-accepting sheet-portion 112, according to additional preferred embodiments of the present invention.

Magnetizable sheet-portion calender 502 is preferably configured to produce magnetizable sheet-portion 110 from raw-material input 103 of flexible magnetizable material 116. It is noted that raw-material input 103 may be produced by first premixing a selected set of raw-material components, as illustrated and described in FIG. 3. Indicia-accepting sheet-portion calender 504 is preferably configured to produce indicia-accepting sheet-portion 112 from second material input 105 of second flexible material 122, most preferably a polymer-based raw material.

As indicia-accepting sheet-portion 112 is formed, the sheet portion is preferably fed into one set of calender rolls 506 of magnetizable sheet-portion calender 502, as shown. Fusion of magnetizable sheet-portion 110 and indicia-accepting sheet-portion 112 preferably occurs within magnetizable sheet-portion calender 502 (at least embodying herein wherein such at least one sheet-portion fuser comprises such at least one magnetizable sheet-portion calender). Thus, magnetizable sheet-portion calender 502 preferably combines the functions of magnetizable sheet-portion former 124, magnetizable sheet-portion modifier 126, material integrator 128, and sheet-portion fuser 132.

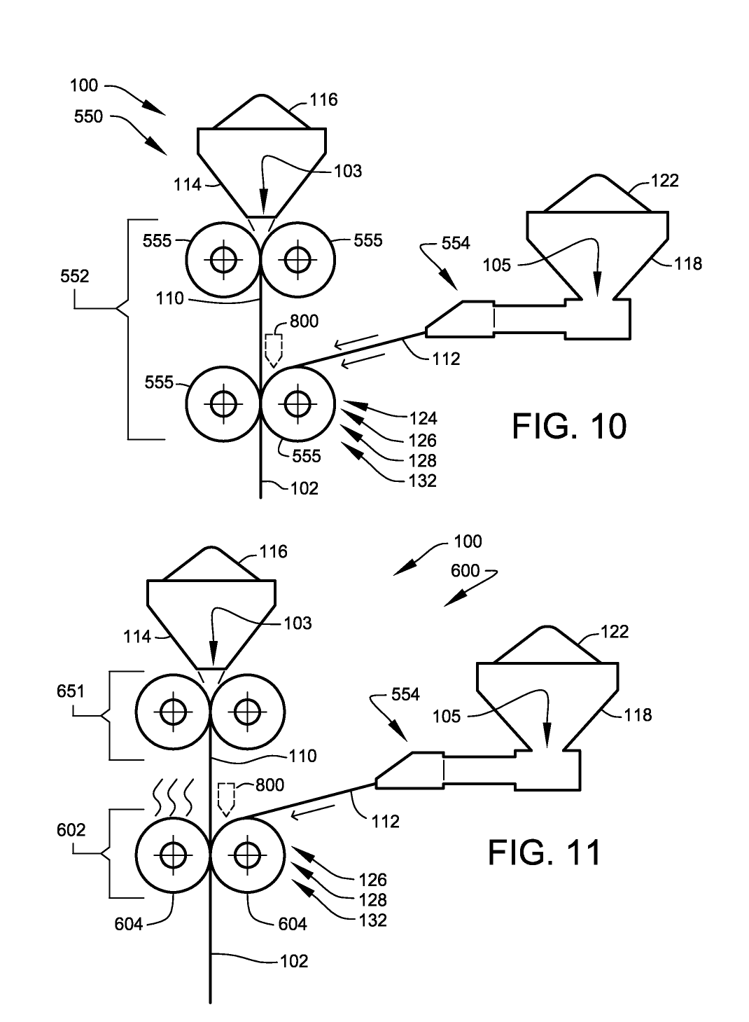

FIG. 10 shows a diagrammatic depiction, illustrating alternate continuous-flow production process 550, preferably utilizing at least one magnetizable sheet-portion calender 552 in combination with at least one indicia-accepting sheet portion extruder 554, according to additional preferred embodiments of the present invention. Magnetizable sheet-portion calender 552 is preferably configured to produce magnetizable sheet-portion 110 from raw-material input 103 of flexible magnetizable material 116, as shown. It is noted that raw-material input 103 may be produced by first premixing a selected set of raw-material components, as illustrated and described in FIG. 3. Indicia-accepting sheet portion extruder 554 is preferably configured to produce indicia-accepting sheet-portion 112 from second material input 105 of second flexible material 122, most preferably comprising a polymer-based raw material.

As indicia-accepting sheet-portion 112 is formed by indicia-accepting sheet portion extruder 554, the resulting extruded sheet portion preferably fed into one set of calender rolls 555 of magnetizable sheet-portion calender 552, as shown. Fusion of magnetizable sheet-portion 110 and indicia-accepting sheet-portion 112 preferably occurs within magnetizable sheet-portion calender 552 (at least embodying herein wherein such at least one sheet-portion fuser comprises such at least one magnetizable sheet-portion calender). Thus, magnetizable sheet-portion calender 552 preferably combines the functions of magnetizable sheet-portion former 124, magnetizable sheet-portion modifier 126, material integrator 128, and sheet-portion fuser 132.

Magnetizable sheet-portion calender 552 preferably functions to smooth and compresses magnetizable writable sheet 102 to provide a smooth, printable surface finish, as required by some printing processes. Calendering is also preferably used to establish a consistent sheet thickness, which is essential in certain printing applications.

FIG. 11 shows a diagrammatic depiction, illustrating alternate continuous-flow production process 600, preferably utilizing a magnetizable sheet-portion calender 651 and the indicia-accepting sheet portion extruder 554 of FIG. 10 in combination with an additional preferred fusing process 602, according to additional preferred embodiments of the present invention.

In alternate continuous-flow production process 600, indicia-accepting sheet-portion 112 is preferably fed from indicia-accepting sheet portion extruder 554 into compression fusing process 602, preferably comprising at least one set of bonding rollers 604, as shown. Fusion of magnetizable sheet-portion 110 and indicia-accepting sheet-portion 112 preferably occurs within bonding rollers 604, as shown. Bonding rollers 604 preferably apply heat and pressure (compression), preferably fusing magnetizable sheet-portion 110 and indicia-accepting sheet-portion 112 into magnetizable writable sheet 102 (at least embodying herein wherein such at least one sheet-portion fuser comprises at least one compressor structured and arranged to provide compression-assist fusing of the at least one magnetizable sheet-portion and the at least one indicia-accepting sheet portion). In a highly preferred embodiment of fusing process 602, bonding rollers 604 are preferably heated by the above-noted pre-set temperature maintainer 414 to promote fusion of the sheets (at least embodying herein wherein such at least one compressor comprises at least one pre-set temperature maintainer structured and arranged to assist maintaining the at least one magnetizable sheet-portion and the at least one indicia-accepting sheet portion at about at least one pre-set temperature during such compression-assisted fusing). Thus, bonding rollers 604 preferably combine the functions of magnetizable sheet-portion modifier 126, material integrator 128, and sheet-portion fuser 132.

Bonding rollers 604 are preferably configured to apply even pressure and heat sufficient to fuse the sheet portions into a unitary sheet. Preferably, bonding rollers 604 are not designed to significantly alter the thickness or surface quality of the resulting magnetizable writable sheet 102.

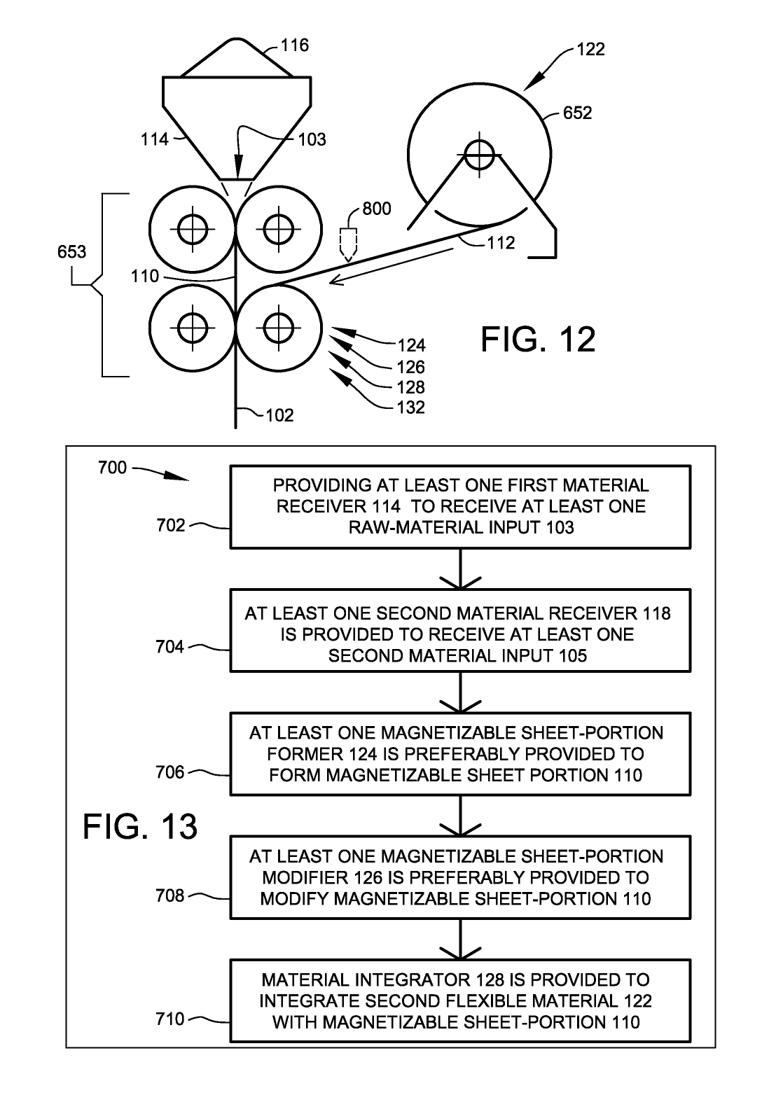

FIG. 12 shows a diagrammatic depiction, illustrating alternate continuous-flow production process 650, utilizing an input of second flexible material 122, preferably in the form of at least one pre-formed indicia-accepting sheet 652, and magnetizable sheet-portion calender 653 utilized to form magnetizable sheet-portion 110 and contemporaneously integrate pre-formed indicia-accepting sheet 652, according to additional preferred embodiments of the present invention.

Preferably, second material receiver 118 comprises at least one pre-formed material receiver 654 structured and arranged to receive second flexible material 122 in the form of pre-formed indicia-accepting sheet 652, as shown. In a highly preferred arrangement of the present embodiment, pre-formed material receiver 654 is configured to receive a roll of such pre-formed indicia-accepting sheet 652, as shown.

In alternate continuous-flow production process 650, magnetizable sheet-portion former 124, magnetizable sheet-portion modifier 126, material integrator 128, and sheet-portion fuser 132 are embodied within magnetizable sheet-portion calender 653. Magnetizable sheet-portion calender 653 is preferably configured to form magnetizable sheet-portion 110 while positioning magnetizable sheet-portion 110 adjacent to and in contact with pre-formed indicia-accepting sheet 652.

Fusion of magnetizable sheet-portion 110 and pre-formed indicia-accepting sheet 652 preferably occurs within magnetizable sheet-portion calender 653, as shown (at least embodying herein at least one sheet-portion fuser structured and arranged to fuse together the at least one magnetizable sheet-portion and the preformed indicia-accepting sheet).

In one preferred embodiment of the present system, pre-formed indicia-accepting sheet 652 preferably comprises at least one paper material and such pre-formed material receiver 654 is preferably configured to receive preformed indicia-accepting sheet 652 comprising a roll of such paper material.

It is noted that, within the preferred embodiments of FIG. 8 through FIG. 12, it may be preferable to introduce one or more optional bond/fusion enhancing treatments 800 at the interface of the sheet materials. Such bond/fusion enhancing treatments 800 may preferably comprise applied tackifiers, catalysts, compatibility agents, corona-discharge treatments, mechanical abrasions, etc.

FIG. 13 shows a flow diagram illustrating a preferred method 700 of the present invention, relating to preferred steps of a preferred continuous-flow production of magnetizable writable sheet 102. Method 700 preferably utilizes the system arrangements of FIG. 1 to produce magnetizable writable sheet 102 using flexible magnetizable material 116 and at least one second flexible material 122 capable of forming an indicia-accepting surface 104. In that regard, method 700 comprises preferred step 702 of providing at least one first material receiver 114 structured and arranged to receive at least one raw-material input 103 of flexible magnetizable material 116. Next, as indicated in preferred step 704, at least one second material receiver 118 is provided, which, as previously noted, is preferably structured and arranged to receive at least one second material input 105 of second flexible material 122. As previously noted, second flexible material 122 may alternately comprise a raw polymer input or a pre-formed indicia-accepting sheet.

Next, as indicated in preferred step 706, at least one magnetizable sheet-portion former 124 is preferably provided, such magnetizable sheet-portion former 124 preferably structured and arranged to form magnetizable sheet portion 110, of magnetizable writable sheet 102, from first raw-material input 103 of flexible magnetizable material 116. Next, as indicated in preferred step 708, at least one magnetizable sheet-portion modifier 126 is preferably provided to modify magnetizable sheet-portion 110 to comprise indicia-accepting surface 104. As illustrated and described in the prior embodiments, at least one material integrator 128 is provided, within magnetizable sheet-portion modifier 126, to integrate second flexible material 122 of indicia-accepting sheet-portion 112 of with magnetizable sheet-portion 110, as indicated in preferred step 710.

Thus, as generally described in the preferred steps above, method 700 preferably enables the production of magnetizable writable sheet 102 a single continuous-flow production process.

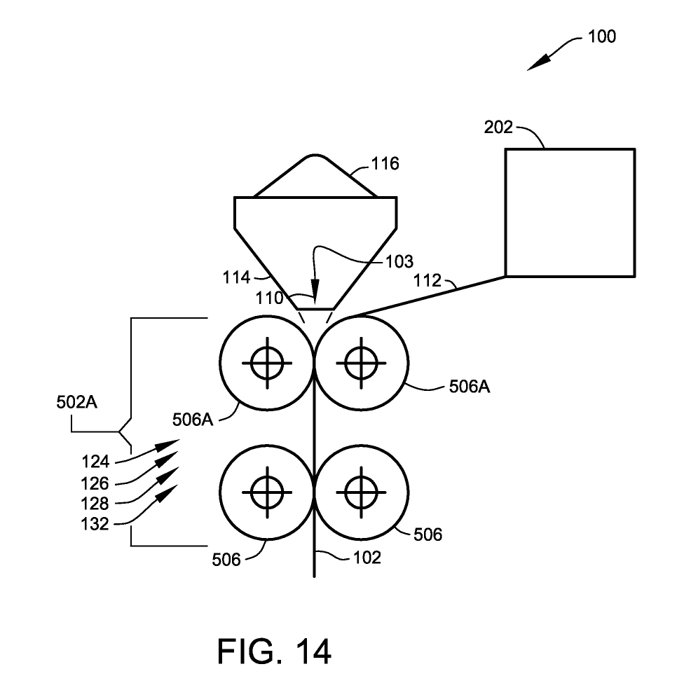

FIG. 14 shows a diagrammatic depiction of another continuous-flow production process, utilizing at least one magnetizable sheet-portion calender and at least one indicia-accepting sheet-portion calender, wherein the magnetizable sheet-portion calender functions to fuse the magnetizable sheet-portion and indicia-accepting sheet-portion, according to additional preferred embodiments of the present invention. This alternate process is similar to the process depicted in prior FIG. 9; however, indicia-accepting sheet-portion 112 is preferably introduced at an initial, preferably a first, set of calender rolls 506A of magnetizable sheet-portion calender 502A, as shown. Fusion of magnetizable sheet-portion 110 and indicia-accepting sheet-portion 112 preferably occurs within magnetizable sheet-portion calender 502A (at least embodying herein wherein such at least one sheet-portion fuser comprises such at least one magnetizable sheet-portion calender). Thus, magnetizable sheet-portion calender 502A preferably combines the functions of magnetizable sheet-portion former 124, magnetizable sheet-portion modifier 126, material integrator 128, and sheet-portion fuser 132.

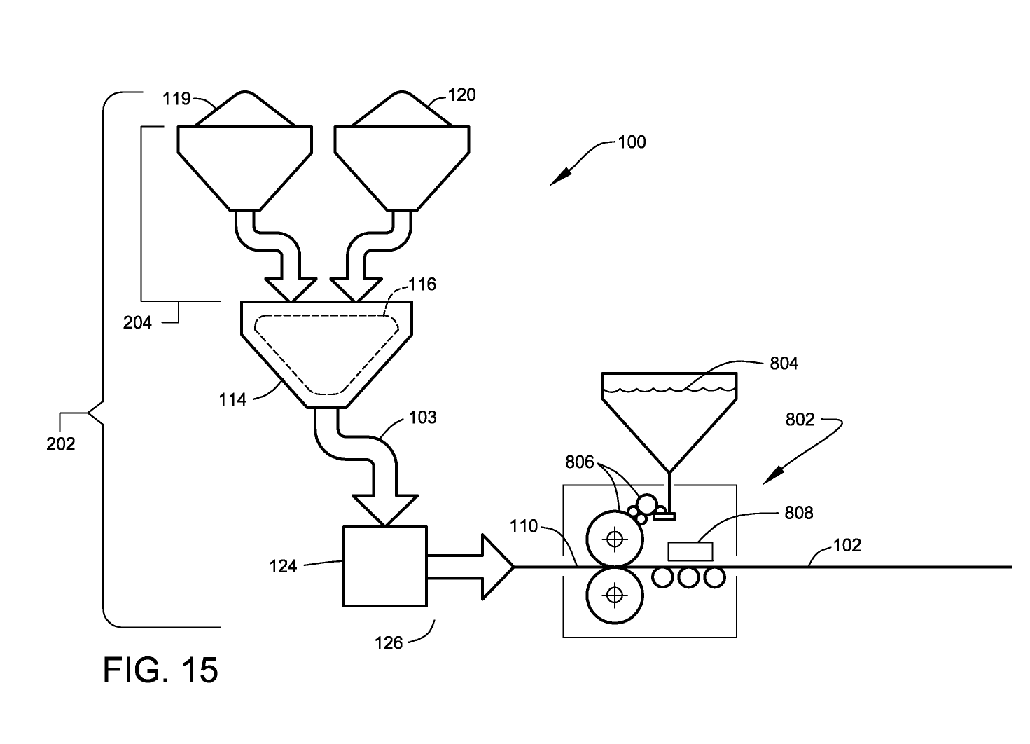

FIG. 15 shows a diagrammatic depiction of another continuous-flow production process, utilizing at least one sheet coater 802, as shown. Sheet coater 802 is preferably configured to form indicia-accepting sheet-portion 112 using at least one fluid-applied material 804. Material 804 is applied to magnetizable sheet-portion 110 entering sheet coater 802. In one preferred process of the present system, material 804 is transferred to the surface of magnetizable sheet-portion 110 from one or more rollers 806, as shown. Upon reading this specification, those skilled in the art will now appreciate that, under appropriate circumstances, considering such issues as cost, available materials, etc., other application methodologies, such as, for example, spray applications, material deposition, dipping, polymer powder fusion coating etc., may suffice. Sheet coater 802 may preferably include one or more curing components 808, such as Ultra-violet (UV) curing apparatus.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A system, relating to continuous-flow production of at least one magnetizable writable sheet comprising at least one flexible magnetizable material and at least one second flexible material capable of forming at least one indicia-accepting surface, said system comprising:
a) continuous-flow producer structured and arranged to produce the at least one magnetizable writable sheet in continuous-flow production process;
b) wherein said continuous-flow producer comprises
i) at least one first material receiver structured and arranged to receive at least one raw-material input of the at least one flexible magnetizable material,
ii) at least one second material receiver structured and arranged to receive at least one second material input of the at least one second flexible material,
iii) at least one magnetizable sheet-portion former structured and arranged to form at least one magnetizable sheet portion, of the at least one magnetizable writable sheet, from the at least one first raw-material input of the at least one flexible magnetizable material, and
iv) at least one magnetizable sheet-portion modifier structured and arranged to modify the at least one magnetizable sheet-portion to comprise the at least one indicia-accepting surface;
c) wherein said at least one magnetizable sheet-portion modifier comprises at least one material integrator structured and arranged to integrate the at least one second flexible material with the at least one magnetizable sheet-portion; and
d) wherein such continuous-flow production of the at least one magnetizable writable sheet comprising the at least one flexible magnetizable material and the at least one second flexible material capable of forming the at least one indicia-accepting surface is provided.

2) The system according to claim 1 wherein said at least one first material receiver comprises at least one pre-mixer structured and arranged to premix at least one flexible binding material with at least one magnetizable material to produce the at least one first raw-material input of the at least one flexible magnetizable material.

3) The system according to claim 1 further comprising:
a) at least one indicia-accepting sheet-portion former structured and arranged to form at least one indicia-accepting sheet portion from the at least one second flexible material;
b) wherein said at least one material integrator comprises at least one sheet-portion fuser structured and arranged to fuse together the at least one magnetizable sheet-portion and the at least one indicia-accepting sheet portion.

4) The system according to claim 1 wherein said at least one magnetizable sheet-portion former comprises at least one magnetizable sheet-portion calender structured and arranged to form the at least one magnetizable sheet-portion using at least one calendering process.

5) The system according to claim 1 further comprising:
a) at least one co-extruder structured and arranged to contemporaneously extrusion form the at least one magnetizable sheet portion from the at least one first raw-material input and at least one indicia-accepting sheet portion from the at least one second material input of the at least one second flexible material;
b) wherein said at least one material integrator comprises at least one sheet-portion fuser structured and arranged to fuse together the at least one magnetizable sheet-portion and the at least one indicia-accepting sheet portion; and
c) said at least one sheet-portion fuser common die tool structured and arranged to physically integrate the at least one magnetizable sheet portion and the at least one indicia-accepting sheet portion in a common die tool.

6) The system according to claim 3 wherein said at least one magnetizable sheet-portion former comprises at least one first extruder structured and arranged to extrusion form the at least one magnetizable sheet portion from the at least one first raw-material input of the at least one flexible magnetizable material.

7) The system according to claim 3 wherein said at least one indicia-accepting sheet-portion former comprises at least one second extruder structured and arranged to extrusion form the at least one indicia-accepting sheet portion from the at least one second flexible material.

8) The system according to claim 3 wherein said at least one indicia-accepting sheet-portion former comprises at least one indicia-accepting sheet-portion calender structured and arranged to form the at least one indicia-accepting sheet-portion using at least one calendering process.

9) The system according to claim 4 wherein:
a) said at least one second material receiver comprises at least one pre-formed material receiver structured and arranged to receive the at least one second flexible material in the form of at least one pre-formed indicia-accepting sheet;
b) said at least one material integrator comprises at least one positioner structured and arranged to position the at least one magnetizable sheet-portion adjacent to and in contact with the preformed indicia-accepting sheet, and
c) at least one sheet-portion fuser structured and arranged to fuse together the at least one magnetizable sheet-portion and the pre-formed indicia-accepting sheet.

10) The system according to claim 9 wherein said at least one pre-formed material receiver is configured to receive the pre-formed indicia-accepting sheet comprising at least one paper material.

11) The system according to claim 5 further comprising at least one surface finishing tool structured and arranged to surface finish at least the at least one indicia-accepting sheet portion to assist forming the at least one indicia-accepting surface.

12) The system according to claim 6 wherein said at least one indicia-accepting sheet-portion former comprises at least one second extruder structured and arranged to extrusion form the at least one indicia-accepting sheet portion from the at least one second flexible material.

13) The system according to claim 12 wherein:
a) said at least one sheet-portion fuser comprises at least one compressor structured and arranged to provide compression-assisted fusing of the at least one magnetizable sheet-portion and the at least one indicia-accepting sheet portion; and
b) said at least one compressor comprises at least one pre-set temperature maintainer structured and arranged to assist maintaining the at least one magnetizable sheet-portion and the at least one indicia-accepting sheet portion at about at least one pre-set temperature during such compression-assisted fusing.

14) The system according to claim 12 further comprising at least one extrudate calender structured and arranged to calender extrudates of said at least one first extruder and said at least one second extruder.

15) The system according to claim 7 wherein said at least one magnetizable sheet-portion former comprises at least one magnetizable sheet-portion calender structured and arranged to form the at least one magnetizable sheet-portion using at least one calendering process.

16) The system according to claim 15 wherein:
a) said at least one sheet-portion fuser comprises at least one compressor structured and arranged to provide compression-assist fusing of the at least one magnetizable sheet-portion and the at least one indicia-accepting sheet portion; and
b) said at least one compressor comprises at least one pre-set temperature maintainer structured and arranged to assist maintaining the at least one magnetizable sheet-portion and the at least one indicia-accepting sheet portion at about at least one pre-set temperature during such compression-assisted fusing.

17) The system according to claim 15 wherein said at least one sheet-portion fuser comprises said at least one magnetizable sheet-portion calender.

18) The system according to claim 8 wherein said at least one magnetizable sheet-portion former comprises at least one magnetizable sheet-portion calender structured and arranged to form the at least one magnetizable sheet-portion using at least one calendering process.

19) The system according to claim 18 wherein said at least one sheet-portion fuser comprises said at least one magnetizable sheet-portion calender.

20) The system according to claim 18 wherein:
a) said at least one sheet-portion fuser comprises at least one compressor structured and arranged to provide compression-assisted fusing of the at least one magnetizable sheet-portion and the at least one indicia-accepting sheet portion; and
b) said at least one compressor comprises pre-set temperature maintainer means for assisting maintaining the at least one magnetizable sheet-portion and the at least one indicia-accepting sheet portion at about at least, one pre-set temperature during such compression-assisted fusing.

21) A system, relating to continuous-flow production of at least one magnetizable writable sheet comprising at least one flexible magnetizable material and at least one second flexible material capable of forming at least one indicia-accepting surface, said system comprising:
a) continuous-flow production process means for producing the at least one magnetizable writable sheet in a single continuous-flow production process;
b) wherein said continuous-flow production process means comprises
i) first material receiver means for receiving at least one raw-material input of the at least one flexible magnetizable material,
ii) second material receiver means for receiving at least one second material input of the at least one second flexible material,
iii) magnetizable sheet-portion former means for forming at least one magnetizable sheet portion, of the at least one magnetizable writable sheet, from the at least one first raw-material input of the at least one flexible magnetizable material, and
iv) magnetizable sheet-portion modifier means for modifying the at least one magnetizable sheet-portion to comprise the at least one indicia-accepting surface;
c) wherein said magnetizable sheet-portion modifier means comprises material integrator means for physically integrating the at least one second flexible material with the at least one magnetizable sheet-portion; and
d) wherein the at least one magnetizable writable sheet is produced by such single continuous-flow production process.

22) A method, relating to continuous-flow production of at least one magnetizable writable sheet comprising at least one flexible magnetizable material and at least one second flexible material capable of forming at least one indicia-accepting surface, said method comprising the steps of:
a) providing at least one first material receiver structured and arranged to receive at least one raw-material input of the at least one flexible magnetizable material;
b) providing at least one second material receiver structured and arranged to receive at least one second material input of the at least one second flexible material;
c) providing at least one magnetizable sheet-portion former structured and arranged to fort at least one magnetizable sheet portion, of the at least one magnetizable writable sheet, from the at least one first raw-material input of the at least one flexible magnetizable material; and
d) providing at least one magnetizable sheet-portion modifier structured and arranged to modify the at least one magnetizable sheet-portion to comprise the at least one indicia-accepting surface;
e) providing within such at least one magnetizable sheet-portion modifier, at least one material integrator structured and arranged to integrate the at least one second flexible material with the at least one magnetizable sheet-portion;
f) wherein such continuous-flow production process is structured and arranged to produce the at least one magnetizable writable sheet in a single continuous-flow production process is provided.

23) The method according to claim 22 wherein such at least one magnetizable sheet-portion modifier comprises at least one sheet coater structured and arranged to fluid coat such at least one magnetizable sheet-portion to produce the at least one magnetizable writable sheet.
